(19) United States
(12) Patent Application Publication
(10) Pub. No.: US 2004/0241332 A1
(43) Pub. Date: Dec. 2, 2004

(54) Method for producing chromophoric and effect-producing multilayer coatings

(76) Inventors: Winfried Kreis, Munster (DE); Renate Weber, Munster (DE); Peter Hoffmann, Senden (DE); Janusch Owtschary, Nottuin (DE); Wolfgang Duschek, Munster (DE); Andreas Ruther, Senden (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/492,639

(22) PCT Filed: Nov. 11, 2002
(86) PCT No.: PCT/EP02/12569

(30) Foreign Application Priority Data
Nov. 13, 2001 (DE) 101 55 709.4

(51) Int. Cl. B05D 7/00

(52) U.S. Cl. 427/402; 427/384

(57) ABSTRACT

A process for producing multicoat color and effect paint systems by applying at least two pigmented coating materials to a primed or unprimed substrate and curing the resulting pigmented films comprises

(I) applying at least one pigmented coating material (A) comprising at least one effect pigment to the primed or unprimed substrate to give the pigmented film(s) (A),

(II) drying the pigmented film(s) (A) without complete curing,

(III) applying at least one pigmented coating material (B) comprising at least one transparent color pigment to the outer surface of the pigmented film(s) (A) to give the pigmented film(s) (B),

(IV) drying the pigmented film(s) (B) without complete curing,

(V) applying at least one unpigmented coating material (C) to the outer surface of the pigmented film(s) (B) to give the unpigmented film(s) (C), and then

(VI) jointly curing the films (A), (B), and (C) to give the multicoat color and effect paint system (A/B/C).

The present invention relates to a novel process for producing multicoat color and effect paint systems on primed and unprimed substrates.

Multicoat color and/or effect paint systems on motor vehicle bodies, especially automobile bodies, are nowadays preferably composed of a plurality of coats of material which are applied atop one another and have different properties.

By way of example, a substrate will have applied to it successively an electrodeposited electrocoat (e-coat) as primer, a surfacer coat or antistonechip primer coat, a basecoat, and a clearcoat.

Within this system, the electrocoat serves in particular to protect the sheet metal against corrosion. By those skilled in the art it is often referred to as the primer.

The surfacer coat serves to mask unevennesses in the substrate and, by virtue of its elasticity, ensures stonechip resistance. Where appropriate, the surfacer coat may also serve to strengthen the hiding power and to deepen the shade of the paint system.

The basecoat contributes the colors and/or the angle-dependent optical effects. Both the brightness (amount) and the color (through wavelength-specific absorption or through interference) of the reflected light may vary depending on the viewing angle, a phenomenon which is also referred to as brightness and/or color flop.

The clearcoat serves to intensify the optical effects and to protect the paint system against mechanical and chemical damage.

Basecoat and clearcoat are often also referred to collectively as the topcoat. For further details, refer to Römpp Lexikon Lacke und Druckfarben, Georg Thieme Verlag, Stuttgart, N.Y., 1998, pages 49 and 51, “automotive finishes”.

In general, the basecoats are produced from coating materials which comprise effect pigments and transparent pigments. Highly colored color and effect basecoats can generally be produced only with a low hiding power. The effect pigments used contribute little to the hiding power. Although aluminum effect pigments would have a good hiding power, the colors formulated with them tend to have a pastel effect.

In order to solve this problem, particularly in the case of deep-red paints, especially deep-red metallic paints, tinted clearcoats are used. These bring about outstanding color saturation. A disadvantage, however, is that the clearcoat material normally used to produce the clearcoat as a protective coat for the basecoat has to be varied in its material composition so that it can disperse the color pigments effectively. This, however, is to the detriment of the protective function of the resulting tinted clearcoat. Furthermore, when tinted clearcoat materials of this kind are used on the line in automotive OEM finishing, cleaning must be especially efficient when changing colors or when changing over from tinted clearcoat to unpigmented clearcoat materials.

Bright red coatings produced on the basis of known color coating materials generally likewise suffer from the problem of inadequate hiding power (cf. Römpp Lexikon Lacke und Druckfarben, Georg Thieme Verlag, Stuttgart, N.Y., 1998, page 124). This is manifested to particular disadvantage in automotive OEM finishing, since it is not possible to realize hiding bright red coatings in the common OEM dry film thicknesses of 25±5 μm. Hiding is generally only achieved at a dry film thickness of more than 30 μm.

This leads to problems in covering the undercoat. The undercoat comprises in the majority of cases a surfacer coat or antistonechip primer coat, which for economic reasons is colored gray or at best a dirty red. As a result, the undercoat can be used for coatings with colors other than bright red. If, then, the color coating lacks sufficient hiding power, the color of the undercoat shows through and thus leads to a shift in color in the direction of achromatic dark or light colors, something which cannot be tolerated.

If a refinish is applied to the bright red automotive OEM finish, then the refinish appears in a stronger brighter red than the original finish, since in this case the original finish shows through. This problem also exists with color coatings in shades which extend from red via orange through to yellow or from red to violet.

In order to solve this problem it is possible to use an undercoat whose color is very similar to that of the color coatings. As a consequence, however, the possibility of universal use of the undercoat is lost, since for every critical color a specific undercoat has to be used. In that case it is also necessary, in order to match sufficiently the color of the color coatings, especially in the case of red, to use the same organic pigments—which are often of very high quality and are expensive—as are also present in the color coating. In many cases, this solution is ruled out on economic grounds alone.

Another way to solve this problem is to choose an achromatic undercoat with a reflectivity as close as possible to the reflectivity of the color coating, measured at the wavelength of minimum absorption of the fully hiding color coating (cf. international patent application WO 97/43052), or to the maximum reflection of the fully hiding color coating (cf. patent applications DE 33 34 961 A1, DE 33 34 960 A1 or CA 2,052,215 A). Even with this procedure, however, the undercoat must be selected on the basis of a specific selection rule, thereby firstly representing an additional process step and secondly likewise ruling out the possibility of universal use of the undercoat.

A third, even more unfavorable solution would be to increase further the amount of the corresponding color pigments in the color coatings. Apart from the fact that this is uneconomic, it adversely affects the profile of properties of the color coatings.

German patent application DE 100 27 291 A1 discloses multicoat color and/or effect paint systems for unprimed metallic substrates based on iron, said systems being producible by

(1) applying a powder coating suspension (powder slurry) comprising at least one hydrophilic color and/or effect pigment directly to the unprimed metallic substrate to give a powder slurry film,

(2) curing the powder slurry film (1) physically or thermally and/or with actinic radiation to give a single-coat color and/or effect paint system;

and then

(2) coating the single-coat color and/or effect paint system with at least one further powder slurry comprising at least one hydrophilic color and/or effect pigment and then curing the powder slurry film(s) physically, thermally and/or with actinic radiation to give a multicoat color and/or effect paint system.

The known multicoat paint system adheres very well to the unprimed substrates and is also satisfies the heightened requirements of the market with uniform distribution of the color and/or effect pigments in the matrix of the multicoat paint systems. The multicoat paint system fulfills the functions of the surfacer coat and antistonechip primer coat as well as that of the electrocoat. It also has the capacity to take over the function of the solid-color topcoat. Moreover, if necessary, it is possible to assign the color and effect functions to different coats: for example, the color function to the first powder slurry coating and the effect function to the second powder slurry coating. As a result it is possible to realize a large number of novel optical effects. Solutions relating to the hiding power of basecoats are not addressed.

German patent application DE 100 17 814 A1 discloses a process for producing a multicoat effect paint system by applying an effect basecoat material pneumatically in one spray pass or in two or more spray passes to a primed or unprimed substrate, drying the resulting basecoat film without curing it, and applying a clearcoat material to the basecoat film, and then curing the resulting clearcoat film together with the basecoat film, the pneumatically produced basecoat spray jet cloud being set in periodic motion relative to its spray direction and relative to the substrate.

Without the addition of Aerosil pastes, talc pastes, white pastes or flatting pastes to the effect basecoat materials, the process provides multicoat effect paint systems which are entirely or substantially free from clouding and are of high overall optical quality.

European patent EP 0 817 684 B1 discloses a process for the multicoat painting of electrically conductive substrates by electrophoretically depositing a first coating film of an electrophoretically depositable aqueous coating material and subsequently applying further coating films, which comprises

1. applying wet-on-wet to the first coating film obtained by electrophoretic deposition

2. applying a second coating film of a first color and/or effect basecoat material and

3. baking the resulting first and second coating films together, and then

4. applying a third coating film of a second color and/or effect basecoat material and then

5. applying a fourth coating film of a clearcoat material and

6. baking the third and fourth coating films together,

7. the overall dry film thickness of the second and third coating films produced from the basecoat materials being between 15 and 40 μm, and

8. the fraction of the second coating film being between 20 and 50% of the overall-dry film thickness of the second and third coating films.

To produce the second and third basecoat films it is preferred to use basecoat materials whose colors are close to one another or, preferably, are identical.

The known process is said to give multicoat paint systems, especially motor vehicle finishes, whose overall level of properties is similar to that of the prior art but in which the overall paint system is of reduced film thickness. The effort involved in tailoring the individual coating films to one another is said to be minimized and the process is said to be able to be carried out with very few baking steps. Whether and, if so, to what extent the known process has the capacity to solve problems with the hiding power of basecoats is not evident from the European patent.

It is an object of the present invention to provide a new process for producing multicoat color and effect paint systems which no longer has the disadvantages of the prior art but instead, while avoiding the use of tinted clearcoat materials, especially adapted undercoats, high basecoat dry film thicknesses and large amounts of pigments in the basecoat materials used, and without the exclusive use of effect pigments imparting high hiding power, gives multicoat color and effect paint systems which have a high hiding power. The new process is also to be easy to realize on the line in automotive OEM finishing without the need for additional investment in new and/or extra equipment. Not least, it is intended that the new process will provide multicoat color and effect paint systems of automobile quality. According to European patent EP 0 352 298 B1, page 15, line 42 to page 17, line 14, this means that the multicoat color and effect paint systems in question must score highly in

(1) gloss,

(2) distinctiveness of image,

(3) uniformity of hiding power,

(4) dry film thickness uniformity,

(5) gasoline resistance,

(6) solvent resistance,

(7) acid resistance,

(8) hardness,

(9) abrasion resistance,

(10) scratch resistance,

(11) impact strength,

(12) intercoat adhesion and adhesion to the substrate, and

(13) weathering stability and UV resistance.

The invention accordingly provides the novel process for producing multicoat color and effect paint systems by applying at least two pigmented coating materials to a primed or unprimed substrate and curing the resulting pigmented films, which comprises

(I) applying at least one pigmented coating material (A) comprising at least one effect pigment to the primed or unprimed substrate to give the pigmented film(s) (A),

(II) drying the pigmented film(s) (A) without complete curing,

(III) applying at least one pigmented coating material (B) comprising at least one transparent color pigment to the outer surface of the pigmented film(s) (A) to give the pigmented film(s) (B),

(IV) drying the pigmented film(s) (B) without complete curing,

(V) applying at least one unpigmented coating material (C) to the outer surface of the pigmented film(s) (B) to give the unpigmented film(s) (C), and then

(VI) jointly curing the films (A), (B), and (C) to give the multicoat color and effect paint system (A/B/C).

In the text below, the novel process for producing multicoat color and effect paint systems by applying at least two pigmented coating materials to a primed or unprimed substrate and curing the resulting pigmented films is referred to as the “process of the invention”.

In the light of the prior art it was surprising and unforeseeable for the skilled worker that the object on which the present invention was based could be achieved by means of the process of the invention. Particularly surprising was the fact that the process of the invention, without using tinted clearcoat materials, specially adapted undercoats, high basecoat dry film thicknesses and/or large amounts of pigments in the basecoats used, gave multicoat color and effect paint systems of automobile quality which have a high hiding power. Moreover, the novel process was easy to realize on the line in automotive OEM finishing without the need for additional investment in new and/or extra equipment. Above all, it was surprising that with the process of the invention it was no longer necessary to use pigmented coating materials (A) necessarily containing only aluminum effect pigments in order to set the necessary hiding power. Even more surprising was the fact that, with the process of the invention, it was no longer necessary to use pigmented coating materials (B) containing exclusively opaque pigments in order to set the necessary hiding power.

The process of the invention starts from a primed or unprimed substrate.

Suitable substrates are all those whose surface is not damaged by the application of heat and/or actinic radiation in the course of curing the films present on said substrate. The substrates are composed preferably of metals, plastics, wood, ceramic, stone, textile, fiber composites, leather, glass, glass fibers, glass wool, rock wool, mineral-bound and resin-bound building materials, such as plasterboard panels and cement slabs or roof tiles, and also composites of these materials.

Accordingly, the process of the invention is outstandingly suitable not only for applications in the fields of automotive OEM finishing and automotive refinish but is also appropriate for coating the interior and exterior of buildings and also doors, windows, and furniture, for industrial coating, including coil coating, container coating, and the impregnation and/or coating of electrical components, and for the coating of white goods, including domestic appliances, boilers, and radiators. In the context of industrial coatings it is suitable for coating virtually all parts and articles for private or industrial use such as domestic appliances, small metal parts such as nuts and bolts, hub caps, wheel rims, packaging, and electrical components, such as motor windings and transformer windings.

With very particular preference the process of the invention is used to coat motor vehicle bodies, especially automobile bodies, and parts thereof, especially mounted components, such as protective plates, wings, doors, trunk lids or spoilers which are produced not of metal but of plastics, especially fiber reinforced plastics, such as SMC (sheet molded compounds), BMC (bulk molded compounds), IMC (injection molded compounds), and RIMC (reaction injection molded compounds).

In the case of electrically conductive substrates it is possible to use primers produced conventionally from electrocoat materials. Both anodic and cathodic electrocoat materials are suitable for this purpose, but especially cathodic electrocoat materials. They may, however, also have a cathodically deposited electrocoat film which is not cured thermally but instead is only dried or partly cured. The electrocoat or electrocoat film may then be coated with customary and known surfacers or antistonechip primers. These may be cured on their own or together with the electrocoat films and/or with the films (A), (B), and (C).

In the case of aluminum substrates a customary and known layer of aluminum oxide produced by anodic oxidation is used as the primer.

Nonfunctionalized and/or nonpolar plastics surfaces may be subjected in a known manner to a pretreatment, such as with a plasma or with flaming, or may be provided with a water-based primer.

In the process of the invention, the coating materials are applied by means of customary and known techniques adapted to the physical form of the coating materials in question. Examples of suitable techniques are fluidized bed coating, spraying, knife coating, brushing, flow coating, dipping, trickling or rolling. Preference is given to employing spray coating materials and spray application techniques, particularly electrostatic spray application (ESTA).

In the process of the invention, the applied coating materials, where appropriate after flashing off and drying, are each appropriately cured in a customary and known manner—physically, thermally, with actinic radiation, or thermally and with actinic radiation, especially UV radiation.

The pigmented coating materials (A) and (B) are preferably cured thermally and the unpigmented coating materials (C) are preferably cured thermally or both thermally and with actinic radiation. Curing with thermal energy and actinic radiation is conventionally referred to as dual cure.

For the heat cure, customary and known means may be used, such as forced air ovens or radiant heaters.

For the actinic radiation cure, customary and known light sources can be used, such as UV lamps.

Depending on whether the coating materials used are one-component systems or two-component or multicomponent systems, where the crosslinking agents and the binders are stored separately from one another until use, the heat cure is conducted preferably at from 120 to 200° C., more preferably from 120 to 180° C., and in particular from 120 to 160° C. (one-component systems) or at below 100° C., preferably below 80° C., more preferably below 60° C., and in particular below 50° C. (two-component and multicomponent systems). In general, the duration of the heat cure is from 1 minute to 2 hours, preferably from 5 minutes to 1 hour, and in particular from 5 to 45 minutes.

For the actinic radiation cure it is preferred to employ a radiation dose of from 10³ to 4×10⁴, preferably from 2×10³ to 3×10⁴, more preferably from 3×10³ to 2.5×10⁴, and in particular from 5×10³ to 2×10⁴ J m⁻². The radiative intensity is from 1×10⁰ to 3×10⁵, preferably from 2×10⁰ to 2×10⁵, more preferably from 3×10⁰ to 1.5×10⁵, and in particular from 5×10⁰ to 1.2×10⁵ W m⁻².

In the process of the invention, at least one, especially one, pigmented coating material (A) comprising at least one, especially one, effect pigment is applied to the substrate to give the pigmented film(s), especially the pigmented film, (A).

The pigmented coating material (A) may further comprise at least one color pigment. It may additionally comprise at least one other pigment.

The pigmented coating materials (A) are preferably one-component systems. They are more preferably aqueous coating materials, particularly customary and known aqueous basecoat materials.

The composition of the pigmented effect coating materials (A) is therefore not critical; rather, it is possible to use the aqueous basecoat materials such as are known from the American patent U.S. Pat. No. 5,114,789 A, column 7, line 41 to column 8, line 33, column 11, lines 24 to 50, and column 13, lines 30 to 40, the European patent EP 0 352 298 B1, page 9, line 19 to page 12, line 38, or patent applications EP 0 089 497 A1, EP 0 256 540 A1, EP 0 260 447 A1, EP 0 297 576 A1, WO 96/12747, EP 0 523 610 A1, EP 0 228 003 A1, EP 0 397 806 A1, EP 0 574 417 A1, EP 0 531 510 A1, EP 0 581 211 A1, EP 0 708 788 A1, EP 0 593 454 A1, DE 4 328 092 A1, EP 0 299 148 A1, EP 0 394 737 A1, EP 0 590 484 A1, EP 0 234 362 A1, EP 0 234 361 A1, EP 0 543 817 A1, WO 95/14721, EP 0 521 928 A1, EP 0 522 420 A1, EP 0 522 419 A1, EP 0 649 865 A1, EP 0 536 712 A1, EP 0 596 460 A1, EP 0 596 461 A1, EP 0 584 818 A1, EP 0 669 356 A1, EP 0 634 431 A1, EP 0 678 536 A1, EP 0 354 261 A1, EP 0 424 705 A1, WO 97/49745, WO 97/49747, EP 0 401 565 A1, EP 0 496 205 A1, EP 0 358 979 A1, EP 4 69 389 A1, DE 2 446 442 A1, DE 3 409 080 A1, DE 195 47 944 A1, DE 197 41 554 A1 or EP 0 817 684, column 5, lines 31 to 45.

The effect pigments are preferably selected from the group consisting of optical effect, fluorescent, electrically conductive, and magnetically shielding pigments, especially optical effect pigments.

The color pigments are preferably selected from the group consisting of organic and inorganic, transparent, colored transparent, and opaque pigments.

The other pigments are preferably selected from the group consisting of anticorrosion pigments, metal powders, organic and inorganic, transparent and opaque fillers and nanoparticles.

Examples of suitable effect pigments are metal flake pigments such as commercial aluminum bronzes, aluminum bronzes chromated in accordance with DE 36 36 183 A1, and commercial stainless steel bronzes, and nonmetallic effect pigments, such as pearlescent pigments and interference pigments, for example, platelet-shaped effect pigments based on iron oxide with a color from pink to brownish red, or liquid-crystalline effect pigments. For further details, refer to Römpp Lexikon Lacke und Druckfarben, Georg Thieme Verlag, 1998, page 176, “effect pigments” and pages 380 and 381, “metal oxide-mica pigments” to “metal pigments”, and to patent applications and patents DE 36 36 156 A1, DE 37 18 446 A1, DE37 19 804A1, DE39 30 601A1, EP0 068 311A1, EP0 264 843A1, EP 0 265 820 A1, EP 0 283 852 A1, EP 0 293 746 A1, EP 0 417 567 A1, U.S. Pat. No. 4,828,826 A, or U.S. Pat. No. 5,244,649 A.

Examples of fluorescent pigments (daylight-fluorescent pigments) are bis(azomethine) pigments.

Examples of suitable electrically conductive pigments are titanium dioxide/tin oxide pigments.

Examples of magnetically shielding pigments are pigments based on iron oxides or chromium dioxide.

Examples of suitable inorganic color pigments are white pigments such as titanium dioxide, zinc white, zinc sulfide or lithopone; black pigments such as carbon black, iron manganese black or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chromium orange; or yellow iron oxide, nickel titanium yellow, chromium titanium yellow, cadmium sulfide, cadmium zinc sulfide, chromium yellow or bismuth vanadate.

Examples of suitable organic color pigments are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments or aniline black.

For further details refer to Römpp Lexikon Lacke und Druckfarben, Georg Thieme Verlag, 1998, pages 180 and 181, “iron blue pigments” to “black iron oxide”, pages 451 to 453, “pigments” to “pigment volume concentration”, page 563, “thioindigo pigments”, page 567, “titanium dioxide pigments”, pages 400 and 467, “naturally occurring pigments”, page 459; “polycyclic pigments”, page 52, “azomethine pigments”, “azo pigments”, and page 379, “metal complex pigments”.

Examples of suitable anticorrosion pigments are micaceous iron ore or zinc salts.

Examples of suitable metal powders are powders of metals and metal alloys, such as aluminum, zinc, copper, bronze or brass.

Examples of suitable organic and inorganic fillers are chalk, calcium sulfates, barium sulfate, silicate such as talc, mica or kaolin, silicas, oxides such as aluminum hydroxide or magnesium hydroxide, or organic fillers such as polymer powders, especially those of polyamide or polyacrylonitrile. For further details refer to Römpp Lexikon Lacke und Druckfarben, Georg Thieme Verlag, 1998, pages 250 ff., “fillers”.

Examples of suitable transparent fillers are those based on silica, alumina or zirconium oxide.

Suitable nanoparticles are selected from the group consisting of hydrophilic and hydrophobic, especially hydrophilic, nanoparticles based on silica, alumina, zinc oxide, zirconium oxide, and the polyacids and heteropolyacids of transition metals, preferably of molybdenum and tungsten, having a primary particle size <50 nm, preferably from 5 to 50 nm, in particular from 10 to 30 nm. The hydrophilic nanoparticles preferably have no flatting effect. Particular preference is given to using nanoparticles based on silica, especially hydrophilic pyrogenic silicas whose agglomerates and aggregates have a chainlike structure and which are preparable by the flame hydrolysis of silicon tetrachloride in an oxyhydrogen flame.

The pigmented coating materials (A) comprise the above-described pigments in customary and known amounts.

Subsequently, the pigmented film or films (A) is or are dried without being completely cured. Thereafter, at least one, especially one, pigmented coating material (B) is applied to the outer surface of said film or films to give at least one, especially one, pigmented film (B).

The pigmented coating material (B) comprises at least one transparent color pigment, i.e., a more or less translucent pigment. Examples of suitable transparent color pigments are the color pigments described above in translucent form. Said coating material may further comprise at least one of the above-described effect pigments and/or other pigments.

The pigmented film or films (B) is or are subsequently dried without full curing. It or their outer surface is then overcoated with at least one, especially one, unpigmented coating material (C), in particular a clearcoat material (C), to give at least one, especially one, unpigmented film (C).

As the unpigmented coating material (C) it is preferred to employ a customary and known one-component or two-component or multicomponent clearcoat material selected from the group consisting of conventional clearcoat materials containing organic solvent, substantially or entirely solvent-free aqueous clearcoat materials, substantially or entirely solvent-free and water-free liquid clearcoat materials (100% systems), substantially or entirely solvent-free and water-free, solid, finely divided powders (powder clearcoat materials), or substantially or fully solvent-free powder clearcoat suspensions (powder slurries), such as are known from patent applications, patents, and publications DE 42 04 518 A1, EP 0 594 068 A1, EP 0 594 071 A1, EP 0 594 142 A1, EP0 604 992 A1, EP 0 596 460 A1, WO 94/10211, WO 94/10212, WO 94/10213, WO 94/22969 or WO 92/22615, U.S. Pat. No. 5,474,811 A1, U.S. Pat. No. 5,356,669 A1or U.S. Pat. No. 5,605,965 A1, DE 42 22 194 1 A, the BASF Lacke+Farben AG product information “Pulverlacke” [powder coating materials], 1990, the BASF Coatings AG brochure “Pulverlacke, Pulverlacke für industrielle Anvendungen” [powder coating materials, powder coatings for industrial applications], January 2000, U.S. Pat. No. 4, 268, 542 A1, DE195 40 977 A1, DE19518392 A1, DE196 17 086 A1, DE-A-196 13 547, DE196 52 813 A1, DE198 14 471A1, EP0 928 800 A1, EP0 636 669 A1, EP0 410 242 A1, EP0 783 534 A1, EP0 650 978 A1, EP0 650 979 A1, EP0 650 985 A1, EP0 540 884 A1, EP0 568 967 A1, EP0 054 505 A1, EP0 002 866 A1, DE 197 09 467 A1, DE 42 03 278 A1, DE33 16 593A1, DE38 36 370A1, DE24 36 186A1, DE20 03 579 B1, WO 97/46549, WO 99/14254, U.S. Pat. No. 5,824,373 A 1, U.S. Pat. No. 4,675,234 A1, U.S. Pat. No. 4,634,602 A1, U.S. Pat. No. 4, 424, 252 A1, U.S. Pat. No. 4,208,313 A1, U.S. Pat. No. 4,163,810 A1, U.S. Pat. No. 4,129,488 A1, U.S. Pat. No. 4,064,161 A1, U.S. Pat. No. 3,974,303 A1, EP 0 844 286 A1, DE43 03 570A1, DE34 07 087A1, DE40 11 045A1, DE40 25 215 A1, DE38 28 098A1, DE40 20 316A1 or DE41 22 743A1.

It is preferred to flash off the unpigmented film (C) in order to remove any organic and/or inorganic solvents present, such as water, after which the films (A), (B) and (C) are jointly cured. Curing may also take place at the same time of the electrodeposition films and/or the surfacer films, where they have not yet been cured individually (extended wet-on-wet technique).

The conjoint curing gives the multicoat color and effect paint system (A/B/C).

In the process of the invention, the effect and optionally color paint systems (A) and the color and optionally effect paint systems (B) are preferably color matched. This means that the two paint systems (A) and (B) may have colors which are different but which add to give a defined mix color. Preferably, however, the paint systems (A) and (B) are similar or, in particular, identical in color.

The colors of the paint systems (A) and (B) are regarded as similar if they are situated in the same quadrant of the color wheel represented by the horizontal section through the CIE 1976 (L*, a*, b*) color space diagram for L*=0. They are regarded as identical if they are situated in the same quadrant in substantially or precisely the same position.

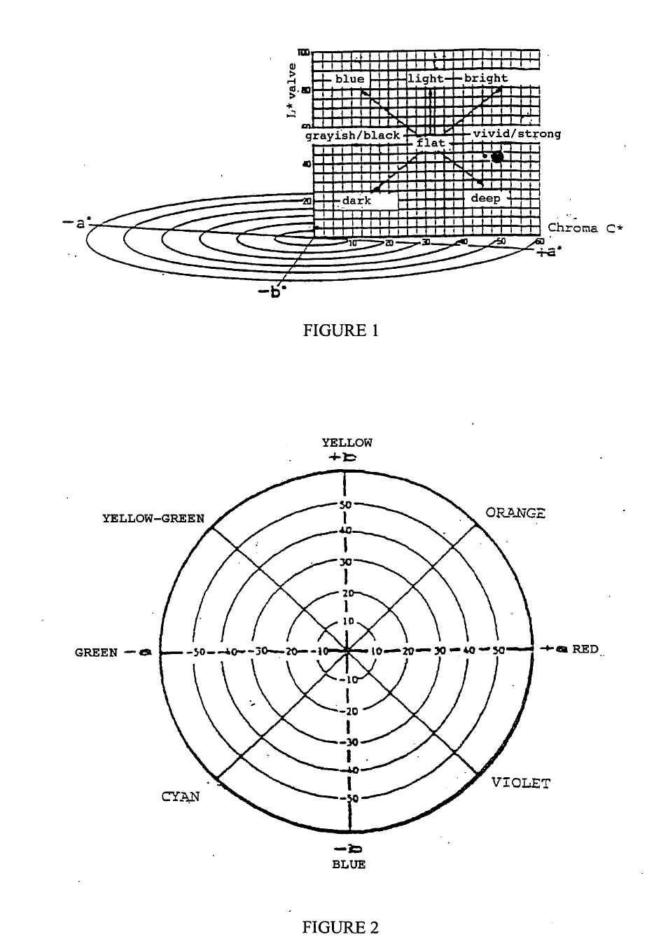

Colors may be defined by reference to FIGS. 1 and 2.

FIG. 1 shows a simplified section through the CIE 1976 (L*, a*, b*) color space diagram based on the color measurement system of Richard S. Hunter (“Photoelectric Tristimulus Colorimetry with Three Filters”, National Bureau of Standards Circular 429, United States Government Printing Office, 1942, reprinted in Journal of the Optical Society of America, 32, 509-538 (1942)). According to that system, a color may be defined fully by defining its lightness, its hue and its saturation or chroma C*. In this system, L* corresponds to the lightness and covers the range from 0 (black) to 100 (white). The hue is described by the values of a* and b*, a* corresponding to the red shades (a*=positive), a* to the green shades (a*=negative), b* to the yellow shades (b*=positive), and b* to the blue shades (b*=negative). The chroma C* is the square root of the sum of the squares of a* and b*.

In FIG. 1 the value of L* is measured on the vertical axis whereas a* and b* are measured as points in a rectangular coordinate system in the plane horizontal to the L* axis. The chroma C* is measured as the perpendicular distance from the L* axis to the points defined by a* and b*.

FIG. 2 shows a horizontal section through the CIE 1976 (L*, a*, b*) color space diagram for constant L*, in this case L*=0. The customary names of the colors as perceived by an observer are given at the periphery of the color wheel (in this regard, cf. also European patent EP 0736073 B1, page 3, lines 15 to 40, or Römpp Lexikon Lacke und Druckfarben, Georg Thieme Verlag, Stuttgart, N.Y., 1998, “L*, a*, b* color space”, page 345, and “CIELAB color distance formula”, “CIE standard chromaticity diagram”, pages 114 to 116).

The process of the invention rapidly and reliably gives multicoat color and effect paint systems of particularly high hiding power in automobile quality. The process of the invention is less restricted in terms of the effect and color pigments used than the conventional processes, thereby enabling simple realization of the production of multicoat color and effect paint systems having novel optical effects alone or in conjunction with other physical effects, such as fluorescence.

1. A process comprising
(I) applying at least one pigmented coating material (A) comprising at least one effect pigment to a substrate to give at least one pigmented film (A),
(II) drying the pigmented film (A) without complete curing,
(III) applying at least one pigmented coating material (B) comprising at least one transparent color pigment to the outer surface of the at least one pigmented film (A) to give at least one pigmented film (B),
(IV) drying the at least one pigmented film (B) without complete curing,
(V) applying at least one unpigmented coating material (C) to the outer surface of the at least one pigmented film (B) to give at least one unpigmented film (C), and then
(VI) jointly curing the films (A), (B), and (C) to give a multicoat color and effect paint system (A/B/C).

2. The process of claim 1, wherein the at least one pigmented coating material (A) further comprises at least one color pigment.

3. The process of claim 1, wherein the at least one pigmented coating material (B) further comprises at least one effect pigment.

4. The process of claim 1, wherein the at least one pigmented film (A) and the at least one pigmented film (B) are color matched.

5. The process of claim 4, wherein the at least one pigmented film (A) and the at least one pigmented film (B) have colors which are situated in the same quadrant of the color wheel that represents the horizontal section through the CIE 1976 (L*, a*, b*) color space diagram for L*=0.

6. The process of claim 4, wherein the at least one pigmented film (A) and the at least one pigmented film (B) have the same color.

7. The process of claim 1, wherein the at least one pigmented coating materials (A) and the at least one pigmented coating material (B) are each aqueous coating materials.

8. The process of claim 1, wherein the at least one pigmented coating material (A) and the at least one pigmented coating material (B) are each thermally curable.

9. The process of claim 1, wherein the at least one pigmented coating material (A) and the at least one pigmented coating material (B) are each one-component systems.

10. The process of claim 1, wherein the at least one unpigmented coating material (C) is selected from the group consisting of clearcoat materials containing organic solvents; solvent-free aqueous clearcoat materials; solvent-free and water-free liquid clearcoat materials; solvent-free and water-free, solid, finely divided powders; solvent-free powder clearcoat suspensions; and combinations thereof.
